(19) United States
(12) Patent Application Publication
(10) Pub. No.: US 2016/0302993 A1
(43) Pub. Date: Oct. 20, 2016

(54) CONSTRUCTIVE DISPOSITION INTRODUCED IN PHYSIOTHERAPY ELECTROMECHANICAL APPARATUS OF LYMPHATIC DRAINAGE FOR LOWER LIMBS

(71) Applicant: Jose Maria Pereira de Godoy, Sao Jose do Rio Preto (BR)

(72) Inventor: Jose Maria Pereira de Godoy, Sao Jose do Rio Preto (BR)

(21) Appl. No.: 14/975,090

(22) Filed: Dec. 18, 2015

(30) Foreign Application Priority Data
Apr. 15, 2015 (BR) 20 2015 008128 1

(51) Int. Cl. A61H 7/00

(52) U.S. Cl. CPC A61H 7/001; A61H 2205/12

(57) ABSTRACT

“CONSTRUCTIVE DISPOSITION INTRODUCED IN PHYSIOTHERAPY ELECTROMECHANICAL APPARATUS OF LYMPHATIC DRAINAGE FOR LOWER LIMBS,” more precisely it is electromechanical device (1) of the type for treatment of lymphedema for lower limbs through the lymphatic drainage; the said apparatus (1) comprises compact fairing (CR) of rectangular prism shape and configured by a receptacle (2) of little height (x), width (y) and length (z) in whose central portion is stored electromechanical module (M1), which is actuated by button (3) provided for one of the side walls (2a) of the receptacle (2), as well as the electromechanical module (M1) is accompanied by a digital panel (4) of all the functions of the apparatus (1), wherein the said panel (4) is also arranged in the same side wall (2a); the said receptacle (2) provides the top wall (2d) cutout (2b1) for centralized installation of the mechanical module (M2) and, consequently, the platform (PL) by setting a space area (AE) wide and centered for the installation of the mechanical module (M2) designed to drive the angular thresholds platform (PL); the platform (PL) is formed by a pair of thresholds (PL1) and (PL2) are interconnected by means of the central member (PL3), which, in turn, is installed in the column (6) that make up the module mechanical (M2), each hearth (PL1) and (PL2); the mechanical module (M2) is configured by a column (6) installed in a cutout (2b1) of the top wall (2b) of said housing (2), wherein said column (6) runs through the cutout (2b1) until it reaches the base (2b) and presents cross section “C” where near the upper wall (6a) and in both side walls (6b) are practiced cutouts (6b1) for the assembly of transverse axis (E) of the support bar (7) of a lever (8) which, in turn, runs through the said cutout (2b1) and is installed on a cam shaft (9) integral electromechanical module (M1), wherein said cam shaft (9) also is installed in the central member (PL3) for angular movement (a1) and (a2) of the sills (PL1)/(PL2); the electromechanical module (M1) provides change means the cycle frequency 30 by minutes.

### TECHNICAL FIELD

This application relates to a new constructive disposition introduced in physiotherapy electromechanical apparatus of lymphatic drainage for lower limbs, which, notably, the said apparatus features innovative construction features that provide improvements in the performance of physiotherapy movements for flexion and extension of the areas of arms and forearms, aimed at stimulation of veno-lymphatic return and treatment of lymphedema for intensive use as monotherapy.

### BACKGROUND

It is known that lymphedema is a lymphatic edema origin determined by absorption or a deficiency in the conduct of lymph. It may be primary without defined or secondary cause by bacterial or fungal infection, traumas, surgeries with removal of lymph nodes, radiotherapy in the region of lymph nodes, metastatic cancer, etc. Clinical control occurs by reducing the volume of the affected limbs, i.e., upper limbs or lower limbs, until they recover the normal state.

Lymphedema may be classified according to the reversibility or irreversibility of features, namely: i) 1^{st} degree—consists of reversible lymphedema with elevation of the member and bed rest for 24 to 48 hours, edema distention with the pressure; ii) 2^{nd} degree—it is an irreversible lymphedema with prolonged rest, fibrosis in the subcutaneous tissue of moderate to severe edema distention with the pressure; iii)3^{rd} degree—refers to the irreversible lymphedema with severe fibrosis in the subcutaneous tissue and elephant aspect of the member.

Therefore, one of lymphedema treatment forms comprises application of pressure on the affected part, encouraging drainage of the lymphatic system; the said elastic compression method is performed through the use of elastic stockings or clamp, as well as the practice of manual lymph drainage massage may help reduce the swelling.

Another form of lymphedema treatment comprises the elevation of the affected limb. However, it is often not practical to maintain the elevated position for long periods, as it becomes a nuisance to the patient. The cleaning of the affected limb is important for the prevention of an infection in the region of the lymphedema, to prevent infections.

Another form of treatment comprises intermittent pneumatic compression system of the lower limbs, which is formed by a compressor apparatus that blows air in chambers which may adopt various forms, such as boot, glove or vest for abdomen. This apparatus exerts pressure on the member where the same is installed. The air chambers that make up the boot, for example, are blown through different pressurization programs and timing, to maintain the parameters specified in the therapy.

However, the practice of exercises performed under medical supervision has greatly improved the flow of the lymphatic system, allowing for the strengthening of muscles and improve the body's ability to absorb protein. Aware of these characteristics, the applicant is depositor of document no. PI 0005369-4 that is physiotherapy apparatus of lymphatic drainage, which is comprised of a single small piece, consisting of a quadrangular laminate base, on which are arranged two interlocking mechanisms, being one mechanical and other electro-electronics, interconnected by levers system; the mechanical system is composed of a pair of thresholds formed of two identical platforms, capable of moving alternately and intermittently in angle ranging from 60° to 90°, through the electronics mechanism and lever system.

In research carried out in specialized databases, it was found documents relating to mechanisms for physiotherapy treatment of the lower limbs, such as the document no. U.S. Pat. No. 5,318,495 consisting of a method for using a device or activation of the lymphatic circulation. The apparatus includes coil springs mounted on cross shaft ends or arm and stirrups of support to the user's heel in a sitting position. To activate the circulation of lymphatic system, user heels are first inserted in the stirrups of support. Then, the user applies a downward force on the stirrups with heels and, finally, the user releases the downward force of the stirrups. The springs are constructed so that the user's legs are moved in an oscillating vertical direction and are particularly suitable for users who are not able to participate in normal activities due to age, illness or accident.

Other document of no. UA97215 relates to method for the treatment of lymphedema member involving a mechanical action on the pathologically altered tissues through the sleeve of multiple circular sections with bladders in which a constant pressure is created. In extreme part of the peripheral bladder, it is created constant pressure within the range of 90 Hg, and in each side of the bladder towards the center, the pressure is lower than 10 hg than the pressure in the foregoing. The mechanical action is conducted for two or four weeks continuously or with time intervals of 0.5 to 7 hours a day with periodic monitoring of the pressure in each bladder.

Other document of no. CN203943695 shows a multi-functional tool for treating thrombosis, comprising a body and a bed of treatment, in which the instrument body comprises a shell, a vacuum pump machine set and negative pressure storage tank, a pressure gauge a switch and an indication lamp disposed at the upper end of the reservoir; It includes a vacuum pump arranged below the negative pressure storage tank, and an operating nozzle is disposed at the right end of the shell; the motion control apparatus is fixed to the bed, and the suction cup is arranged on the device motion control; a three way apparatus is disposed between the negative pressure storage tank and the vacuum pump machine assembly, and the place of operation is connected with three-way apparatus through a conduit; the pressure meter is connected with the negative pressure storage tank, and the switch is electrically connected to the engine; the operating nozzle may be connected with the suction tank through a hose, and the engine is electrically connected with the vacuum pump.

The documents cited in the above paragraphs, despite belonging to the same field of application, i.e., treatment of lymphedema, thrombosis and likened, do not present any of the object's characteristics now perfected, thereby ensuring that it meets the legal requirements for patentability.

### SUMMARY

Aiming to present improvements in the consumer market, the applicant developed constructive disposition introduced in physiotherapy electromechanical apparatus of lymphatic drainage for lower limbs. The said apparatus comprises a fairing which is installed the electromechanical module responsible for moving the mechanical module installed in the upper base of the fairing, in turn, this mechanical module which is formed by a set of levers that move angularly a platform formed by a pair of sills.

The constructive improvements in the physiotherapy apparatus comprises mainly a constituent of a composite and compact fairing, a horizontal receptacle configuring a special area appropriate for installation of a mechanical module, designed for angular movement of the sill platform, in order to compose an appropriate peripheral space for the positioning of the feet of the patient with lymphedema.

Another improvement consists in the new configuration of the sills devoid of peripheral side wall and, the said sills have decreased in size in calcaneus portion in order to reduce the possibility of scar decubitus in the ankle and heel.

Likewise, the platform comprising each sill has a new innovated angulation made possible by the innovated structure of the pedestal and levers, and consequently, the change of the angle of flexion and plant extension of the patient.

Another improvement in the apparatus consists in the addition of a cushion to raise the member to prevent bedsore of decubitus type due to repeated movements of a higher frequency.

The new constructivity of the platform assembly in a central pedestal promotes the elevation of height of the sills in approximately 22 cm and, consequently, elevation of legs, promoting gravitational pressure gain.

Another improvement is provided by the electromechanical module that allows the change of the cycle frequency 30 by minutes, and the entire apparatus control occur through digital panel, facilitating its use.

The association of all the constructive improvements in the electromechanical apparatus allows the possibility of intensive treatment for eight hours or more as monotherapy, as well as provides greater tolerability of the apparatus.

### DESCRIPTION OF THE FIGURES

To complement the present description in order to obtain a better understanding of the features of the application and according to a preferred practical embodiment thereof, a set of drawings accompanies the description attached, where, in exemplified way, although not limiting, represented as follows:

FIG. 1 represents a front view perspective;

FIG. 2 shows a rear perspective view;

FIG. 3 shows a side view;

FIG. 4 reveals a top view;

FIGS. 5 and 6 shows a longitudinal section A.A indicated in previous figure illustrating the variation of the angle of flexion and plant extension.

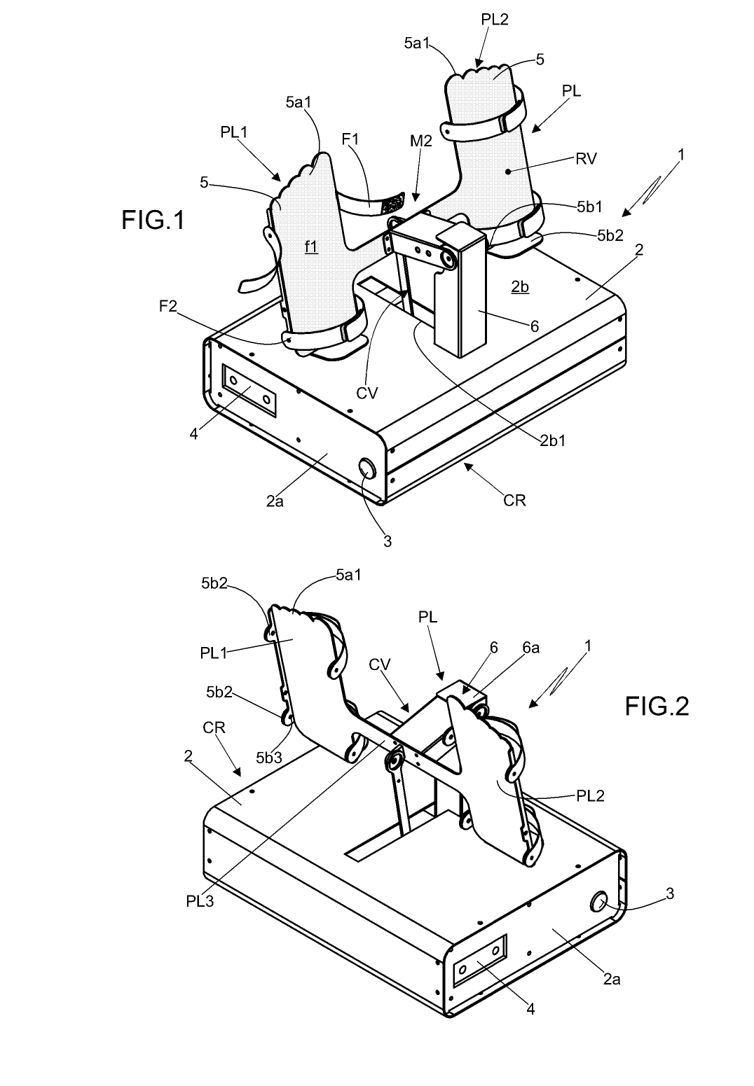

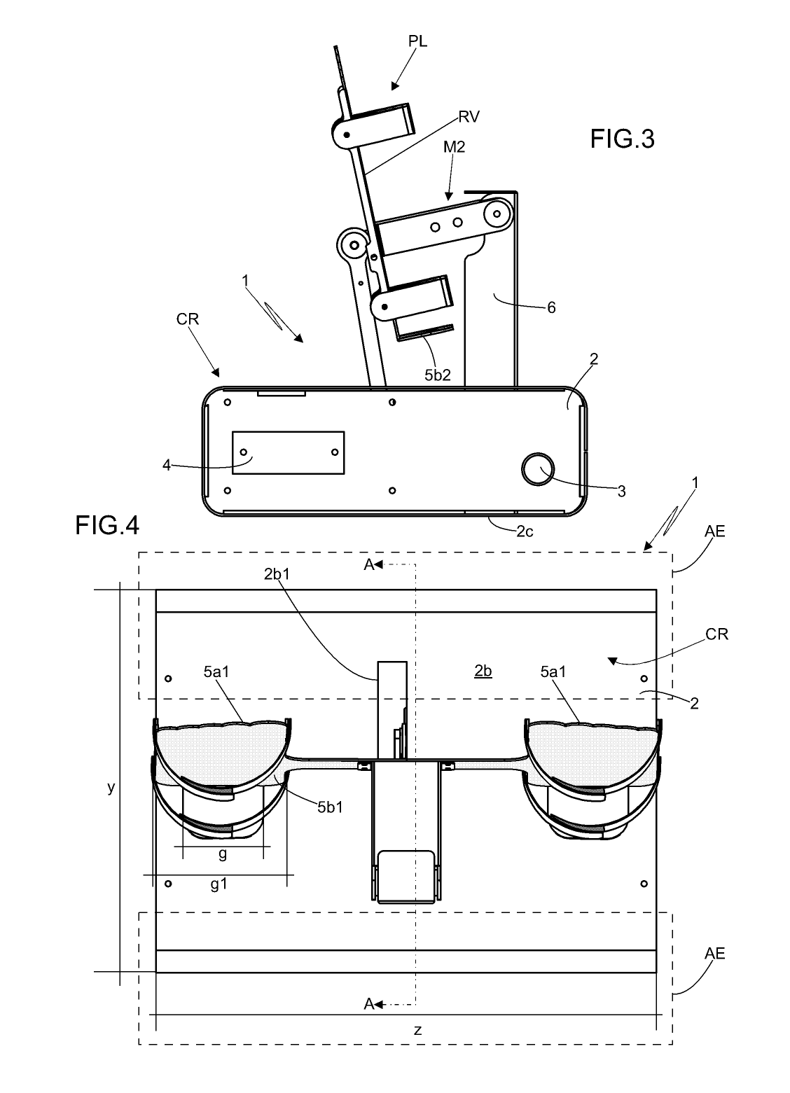

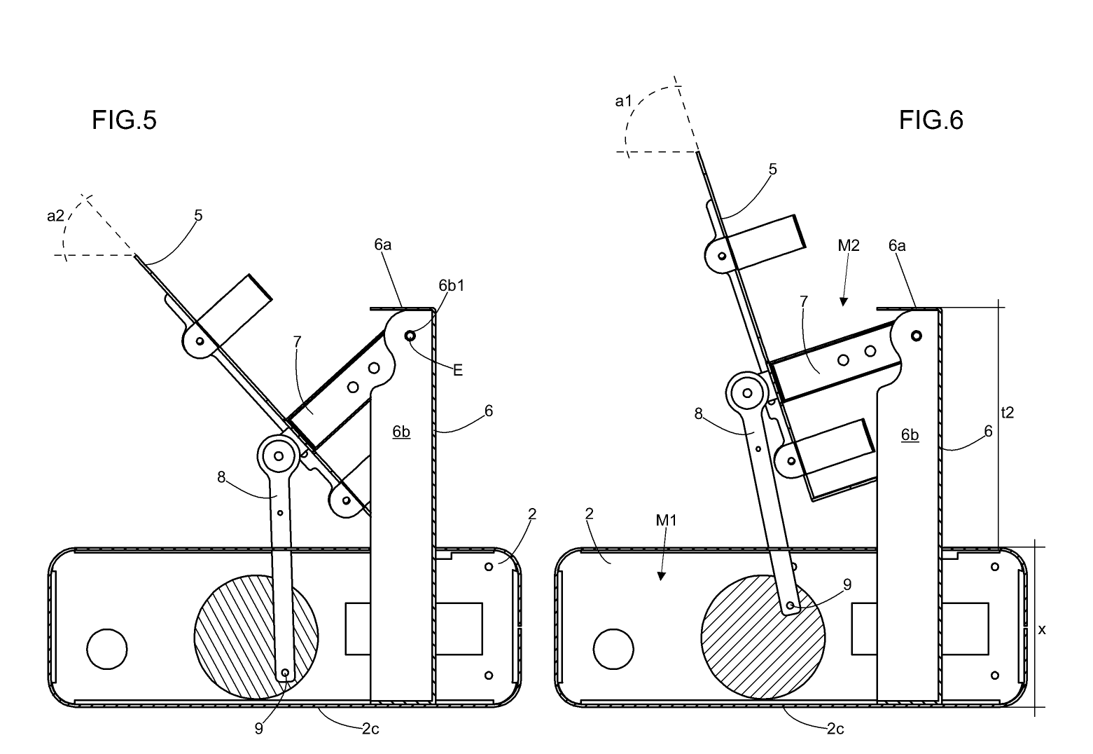

### DETAILED DESCRIPTION

With reference to the illustrated drawings, the present application refers to a “CONSTRUCTIVE DISPOSITION INTRODUCED IN PHYSIOTHERAPY ELECTROMECHANICAL APPARATUS OF LYMPHATIC DRAINAGE FOR LOWER LIMBS,” more precisely it is an electromechanical apparatus (1) of the type for treatment of lymphedema for lower members through lymphatic drainage. The said apparatus comprises fairing (CR) which is installed the electromechanical module (M1) responsible for moving the mechanical module (M2), in turn, formed by a set of levers (CV) that move angularly the platform (PL) formed by a pair of sills (PL1) and (PL2) and devised to accommodate the feet of the patient (not shown). The pair of sills (PL1) and (PL2) are moved intermittently in a variable angle to allow the physiological stimulus of muscle contraction and compression of blood vessels. The said constructiveness of the apparatus (1) is required in the document filed by the applicant No P10005369-4 deposited on Nov. 13, 2000.

According to the present application, the constructive improvements in the physiotherapy apparatus comprises the prediction of a compact fairing (CR) of rectangular prism shape and configured by a receptacle (2) of little height (x), width (y) and length (z) in whose central portion is stored the electromechanical module (M1) which is triggered by button (3) provided for one of the side walls (2a) of the receptacle (2), as well as the electromechanical module (M1) is accompanied by a touch panel (4) controller of all the functions of the apparatus (1), wherein the said panel (4) is also disposed in the same side wall (2a). The said receptacle (2) provides for the top wall (2b) cutout (2b1) for centralized installation of the mechanical module (M2) and, consequently, the platform (PL) by setting a space area (AE) wide and centered for the installation of the mechanical module (M2) designed to the angular movement of the platform of sills (PL).

In a preferred constructive version, the platform (PL) is formed by a pair of sills (PL1) and (PL2) interconnected by means of the central member (PL3), which, in turn, is installed in the column (6) that comprises the mechanical module (M2), each sill (PL1) and (PL2) is formed by a plate (5) of rectangular upper edge (5a1) representing the peripheral shape of human fingers. From the lower edge (5b1) of each plate (5) are developed orthogonal walls (5b2) whose width (g) is reduced in relation to the width (g1) of the plate (5).

From the lateral edges of each plate (5) are developed toward the rear side pair of elongate appendages (5b2) where are practiced the holes (5b3) to the assembly of tracks (F1) and (F2) provided with means of closure, such as Velcro and idealized to stabilize the patient's feet when seated at each sill (PL1)/(PL2), while the entire face (f1) of contact with the patient's feet (not shown) provides rubberized coating (RV).

The mechanical module (M2) is configured by a column (6) installed in a cutout (2b1) of the top wall (2b) of the said receptacle (2), wherein the said column (6) runs through the cutout (2b1) until the base (2c) and displays cross section “C” where near the upper wall (6a) and two side walls (6b) are practiced cutouts (6b1) to assembly transverse axis (E) of the support bar (7) of the lever (8) which, in turn, runs through the said cutout (2b1) and is installed on a cam shaft (9) integral part of the electromechanical module (M1), wherein the said cam shaft (9) also is installed in central member (PL3) for angular movement (α1) and (α2) of the sills (PL1)/(PL2).

The said angles (α1) and (α2) of the sills (PL1)/(PL2) may be preferably and respectively 80° when in the rest position and 55° when moved by the eccentric shaft (9) for changing of the angle of flexion and plant extension of the patient.

The said column (6) has elevated height (t) by positioning the sills (PL1)/(PL2) in height (t1) of about 22 cm and, consequently, raising the feet of the patient to the gravitational pressure.

The electromechanical module (M1) includes modification means in the cycle frequency 30 min, while association of all constructive improvements in the electromechanical device (1) allows the possibility of intensive treatment for eight hours or more as monotherapy.

The physiotherapy electromechanical apparatus has significant advantages over the prior art documents, and it fits perfectly in the criteria that define the application, i.e., performs the combination and modification of elements already known, bringing new shape or disposal, resulting in functional improvement in its use or manufacture.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

1. “CONSTRUCTIVE DISPOSITION INTRODUCED IN PHYSIOTHERAPY ELECTROMECHANICAL APPARATUS OF LYMPHATIC DRAINAGE FOR LOWER LIMBS,” more precisely it is electromechanical device (1) of the type for treatment of lymphedema for lower limbs through the lymphatic drainage; the said apparatus (1) comprises fairing (CR) in which is installed electromechanical module (M1) responsible for moving the mechanical module (M2), in turn, formed by a set of levers (CV) which angularly move the platform (PL) configured by a pair of sills (PL1) and (PL2) and devised to accommodate the feet of the patient; the pair of sills (PL1) and (PL2) are moved intermittently in a variable angle to allow the physiological stimulus of muscle contraction and compression of blood vessels; the said constructiveness of the apparatus (1) is granted in this document deposited by the applicant No P10005369-4 deposited on Nov. 13, 2000; characterized by physiotherapy apparatus comprises the prediction of a compact fairing (CR) of rectangular prism shape and configured by a receptacle (2) of little height (x), width (y) and length (z) in whose central portion is stored the electromechanical module (M1) which is triggered by button (3) provided for one of the side walls (2a) of the receptacle (2), as well as the electromechanical module (M1) is accompanied by a digital panel (4) controlling all functions of the apparatus (1), wherein the said panel (4) is also disposed in the same side wall (2a); the said receptacle (2) provides for the top wall (2b) cutout (2b1) for centralized installation of the mechanical module (M2) and, consequently, the platform (PL) by setting a space area (AE) wide and centered for the installation of the mechanical module (M2) designed to drive the angular movement of the sill platform (PL); the platform (PL) is formed by a pair of sills (PL1) and (PL2) interconnected by means of the central member (PL3), which, in turn, is installed in the column (6) that make up the Mechanical module (M2), and each sill (PL1) and (PL2) is formed by a plate (5) of rectangular and the upper edge (5a1) representing the peripheral shape of human fingers; from the bottom edge (5b1) of each plate (5) develop orthogonal walls (5b2) whose width (g) shows is reduced in relation to the width (g1) of the plate (5); from the side edges of each plate (5) is developed toward the rear side pair of elongate appendages (5b2) are practiced where the holes (5b3) for the assembly of tracks (F1) and (F2) provided with closure means, such as Velcro and idealized to stabilize the patient's feet when seated at each sill (PL1)/(PL2), while the entire face (f1) of contact with the patient's feet provides rubberized coating (RV); the mechanical module (M2) is configured by a column (6) installed in a cutout (2b1) of the top wall (2b) of the said receptacle (2), wherein the said column (6) runs through the cutout (2b1) until it reaches the base (2c) and displays cross section “C” where near the upper wall (6a) and two side walls (6b) are practiced cutouts (6b1) for the assembly of transverse axis (E) of the support bar (7) a lever (8) which, in turn, runs through the said cutout (2b1) and is installed on a cam shaft (9) integral electromechanical module (M1), wherein the said cam shaft (9), too, is installed on member central (PL3) for angular movement (α1) and (α2) of the sills (PL1)/(PL2); the electromechanical module (M1) provides change means in the cycle frequency by 30 minutes.

2. “CONSTRUCTIVE DISPOSITION INTRODUCED IN PHYSIOTHERAPY ELECTROMECHANICAL APPARATUS OF LYMPHATIC DRAINAGE FOR LOWER LIMBS,” according to the preceding claim, characterized by the angle (α1) of the sills (PL1)/(PL2) to be 80°, when in rest position.

3. “CONSTRUCTIVE DISPOSITION INTRODUCED IN PHYSIOTHERAPY ELECTROMECHANICAL APPARATUS OF LYMPHATIC DRAINAGE FOR LOWER LIMBS,” according to the preceding claim, characterized by the angle (α2) of the sills (PL1)/(PL2) to be 55°, when in rest position.

4. “CONSTRUCTIVE DISPOSITION INTRODUCED IN PHYSIOTHERAPY ELECTROMECHANICAL APPARATUS OF LYMPHATIC DRAINAGE FOR LOWER LIMBS,” according to the preceding claim, characterized by the column (6) to present elevated height, positioning the sills (PL1)/(PL2) in height (t1) of approximately 22 cm.
